(19) United States
(12) Patent Application Publication
(10) Pub. No.: US 2023/0222319 A1
(43) Pub. Date: Jul. 13, 2023

(54) LEARNING METHOD, LEARNING APPARATUS AND PROGRAM

(71) Applicant: NIPPON TELEGRAPH AND TELEPHONE CORPORATION, Tokyo (JP)

(72) Inventor: Tomoharu IWATA, Tokyo (JP)

(73) Assignee: NIPPON TELEGRAPH AND TELEPHONE CORPORATION, Tokyo (JP)

(21) Appl. No.: 18/007,707

(22) PCT Filed: Jun. 8, 2020
(86) PCT No.: PCT/JP2020/022565

§ 371 Date: Dec. 1, 2022

(51) Int. Cl. G06N 3/0442; G06N 3/045

(52) U.S. Cl. CPC G06N 3/0442; G06N 3/045

(57) ABSTRACT

A learning method, executed by a computer, according to one embodiment includes an input procedure for receiving a series data set set X={X_{d}}_{d}_{^{∈}}_{D} composed of series data sets X_{d} for learning in a task d∈D when a task set is set as D, a sampling procedure for sampling the task d from the task set D and then sampling a first subset from a series data set X_{d} corresponding to the task d and a second subset from a set obtained by excluding the first subset from the series data set X_{d}, a generation procedure for generating a task vector representing characteristics of the first subset using parameters of a first neural network, a prediction procedure for calculating, from the task vector and series data included in the second subset, a predicted value of each value included in the series data using parameters of a second neural network, and a learning procedure for updating learning target parameters including the parameters of the first neural network and the parameters of the second neural network using an error between each value included in the series data and the predicted value corresponding to each value.

### TECHNICAL FIELD

The present invention relates to a learning method, a learning apparatus, and a program.

### BACKGROUND ART

In general, machine learning methods learn models using task-specific learning data sets. Although a large amount of learning data sets are required to achieve high performance, there is a problem that it costs a lot to prepare a sufficient amount of learning data for each task.

In order to solve this problem, a meta-learning method for achieving high performance even with a small number of learning data by utilizing learning data of different tasks has been proposed (for example, NPL 1).

### CITATION LIST

### Non Patent Literature

[NPL 1] Finn, Chelsea, Pieter Abbeel, and Sergey Levine, “Model-agnostic meta-learning for fast adaptation of deep networks”. Proceedings of the 34th International Conference on Machine Learning, 2017.

### SUMMARY OF THE INVENTION

### Technical Problem

However, existing meta-learning methods have a problem that sufficient performance cannot be achieved in series data.

In view of the above circumference, an object of one embodiment of the present invention is to allow learning of a high-performance prediction model for series data.

### Means for Solving the Problem

To accomplish the aforementioned object, a learning method, executed by a computer, according to one embodiment includes an input procedure for receiving a series data set set X={X_{d}}_{d}_{^{∈}}_{D} composed of series data sets X_{d} for learning in a task d∈D when a task set is set as D, a sampling procedure for sampling the task d from the task set D and then sampling a first subset from a series data set X_{d} corresponding to the task d and a second subset from a set obtained by excluding the first subset from the series data set X_{d}, a generation procedure for generating a task vector representing characteristics of the first subset using parameters of a first neural network, a prediction procedure for calculating, from the task vector and series data included in the second subset, a predicted value of each value included in the series data using parameters of a second neural network, and a learning procedure for updating learning target parameters including the parameters of the first neural network and the parameters of the second neural network using an error between each value included in the series data and the predicted value corresponding to each value.

### Effects of the Invention

It is possible to learn a high-performance prediction model for series data.

### BRIEF DESCRIPTION OF DRAWINGS

FIG. 1 is a diagram showing an example of a functional configuration of a learning apparatus according to the present embodiment.

FIG. 2 is a flowchart showing an example of a flow of learning processing according to the present embodiment.

FIG. 3 is a diagram showing an example of a hardware configuration of the learning apparatus according to the present embodiment.

### DESCRIPTION OF EMBODIMENTS

Hereinafter, one embodiment of the present invention will be described. In the present embodiment, a learning apparatus 10 capable of allowing learning of a high-performance prediction model for time-series data when time-series data that is one piece of series data is a target and a set of a plurality of pieces of time-series data is provided will be described.

It is assumed that time-series data set sets X={X_{d}}_{d}_{^{∈}}_{D} of |D| tasks are provided to the learning apparatus 10 according to the present embodiment as input data at the time of learning. Here, the following formula represents a time-series data set of a task d.

X_{d}={x_{dn}}ₙ₌₁^{N}^{_{d}} [Math. 1]

x_{dn}=[x_{dn1}, . . . ,x_{dnT}_{_{dn}}] [Math. 2]

The above formula represents an n-th time series of the task d. Further, x_{dnt} represents a value at a time t in the n-th time series of the task d, T_{dn} represents the time-series length of the n-th time series of the task d, and N_{d} represents the number of time series of the task d. Meanwhile, x_{dnt} may be multidimensional.

It is assumed that a small number of time-series data sets (hereinafter referred to as “support sets”) in a target task d* are provided at the time of testing (or at the time of operating a prediction model, and the like). Here, the goal of the learning apparatus 10 is to learn a prediction model for more accurately predicting future values of a certain time series (hereinafter, this time series is referred to as a “query”) related to a target task.

<Functional Configuration>

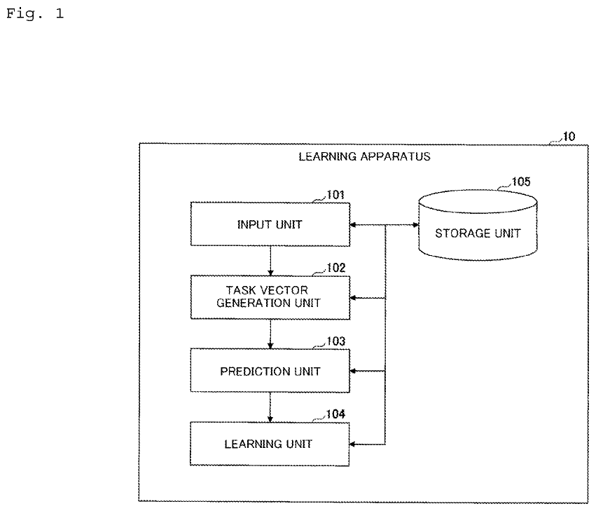

First, a functional configuration of the learning apparatus 10 according to the present embodiment will be described with reference to FIG. 1. FIG. 1 is a diagram showing an example of the functional configuration of the learning apparatus 10 according to the present embodiment.

As shown in FIG. 1, the learning apparatus 10 according to the present embodiment has an input unit 101, a task vector generation unit 102, a prediction unit 103, a learning unit 104, and a storage unit 105.

The storage unit 105 stores time-series data set sets X, parameters that are learning targets, and the like.

The input unit 101 receives a time-series data set set X stored in the storage unit 105 at the time of learning. The input unit 101 receives a support set and queries of the target task d* at the time of testing.

Here, the learning unit 104 samples a task d from a task set D and then samples a support set S and a query set Q from a time-series data set X_{d} included in the time-series data set set X at the time of learning. The support set S is a support set used at the time of learning (that is, a small number of time-series data sets in the sampled task d), and the query set Q is a set of queries used at the time of learning (that is, time series of the sampled task d).

The task vector generation unit 102 generates a task vector representing the property of a task corresponding to the support set using the support set.

It is assumed that a time-series data set of a certain task is provided as a support set represented by the following formula.

S={xₙ}ₙ₌₁^{N} [Math. 3]

N is the number of time series included in the support set S. Here, the task vector generation unit 102 calculates a task vector representing the characteristics of the time series at each time of the time-series data set according to a neural network. For example, the task vector generation unit 102 can use a bidirectional long short-term memory (LSTM) as the neural network and use a latent layer (hidden layer) as a task vector. That is, the task vector generation unit 102 can calculate a task vector hₙₜ at time t in the n-th time series according to, for example, the following formula (1).

hₙₜ=f(h_{n,t-1},xₙₜ) (1)

Here, f is a bidirectional LSTM. Further, hₙₜ represents a latent layer at time t in the bidirectional LSTM, and xₙₜ represents a value at time t in a time series xₙ.

The prediction unit 103 predicts a value at a time t+1 following a certain time t in a query by using the task vector generated by the task vector generation unit 102 and the query.

First, the prediction unit 103 calculates a query vector representing the characteristics of a given query x (that is, a time series x*) according to a neural network. For example, the prediction unit 103 can use an LSTM as the neural network and use a latent layer thereof as a query vector. That is, the prediction unit 103 can calculate a query vector zₜ at time t according to, for example, the following formula (2).

zₜ=g(zₜ₋₁,xₜ*) (2)

Here, g is the LSTM. Further, zₜ represents a latent layer of the LSTM at time t, and xₜ* represents a value at time t in the time series x*.

Next, the prediction unit 103 calculates a value (predicted value) of the time following the certain time in the query according to a neural network using the query vector and the task vector. For example, the prediction unit 103 calculates a vector a according to the following formula (3) using an attention mechanism and then calculates a predicted value of the time following the certain time in the query x according to the following formula (4).

$$\begin{matrix}[ Math . 4 ] & \\ a = {\sum }_{n = 1}^{N} {\sum }_{t = 1}^{{T}_{n}} \frac{exp ( {( {Kh}_{nt} )}^{τ} Qz )}{{\sum }_{{n}^{′} = 1}^{N} {\sum }_{{t}^{′} = 1}^{{T}_{{n}^{′}}} exp ( {( Qz )}^{τ} {Kh}_{{n}^{′} , {t}^{′}} )} {Vh}_{nt} & ( 3 )\end{matrix}$$

$${\hat{x}}_{t + 1} = u ( a , z ) \qquad ( 4 )$$

Here, K, Q, and V represent parameters of the attention mechanism, and u represents a neural network. Further, z is the task vector of the query x* at the certain time (for example, z=zₜ when the certain time is t), \hat{ }xₜ₊₁ (to be exact, the hat “\hat{ }” should be written directly above x) is a predicted value of the time following the certain time in the query x*. τ represents transposition.

At the time of learning, for each query included in the query set Q, a predicted value at each time in the query (that is, a predicted value \hat{ }xₜ₊₁ at the next time t+1 when z=zₜ for each time t in the query) is calculated. On the other hand, at the time of testing, a predicted value at a future time that is not included in a query with respect to the target task (for example, a predicted value \hat{ }x_{T+1} at the next time T+1 when z=z_{T} if the query includes values up to the time T) is calculated.

The learning unit 104 samples the task d from the task set D using the time-series data set set X input through the input unit 101 and then samples the support set S and the query set Q from the time-series data set X_{d} included in the time-series data set set X. The size of the support set S (that is, the number of time series included in the support set S) is set in advance. Similarly, the size of the query set Q is also set in advance. Further, at the time of sampling, the learning unit 104 may perform sampling randomly or may perform sampling according to any distribution set in advance.

Then, the learning unit 104 updates (learns), using an error between the predicted value at time t calculated from a query included in the support set S and the query set Q and the value at time t in the query, learning target parameters (that is, parameters of the neural networks f, g and u, and the parameters K, Q and V of the attention mechanism) such that the error decreases.

For example, in the case of a regression problem, the learning unit 104 may update learning target parameters such that an expected test error represented by the following formula (5) is minimized.

[Math. 5]

[symbol]

_{d˜D}[ [symbol] _{(S,Q)·X}_{_{d}}[L(S,Q;Φ)]] (5)

Here, E represents an expected value, Φ represents a parameter set that is a learning target, and L represents an error represented by the following formula (6).

$$\begin{matrix}[ Math . 6 ] & \\ L ( S , Q ; Φ ) = \frac{1}{{N}_{Q}} {\sum }_{n = 1}^{{N}_{Q}} \frac{1}{{T}_{n}} {\sum }_{t = 1}^{{T}_{n}} {‖ {\hat{x}}_{nt} - {x}_{nt} ‖}^{2} & ( 6 )\end{matrix}$$

That is, L represented by the above formula (6) indicates an error in the query set Q when the support set S is provided. N_{Q} represents the size of the query set Q. However, a negative log likelihood may be used as L instead of an error.

<Flow of Learning Processing>

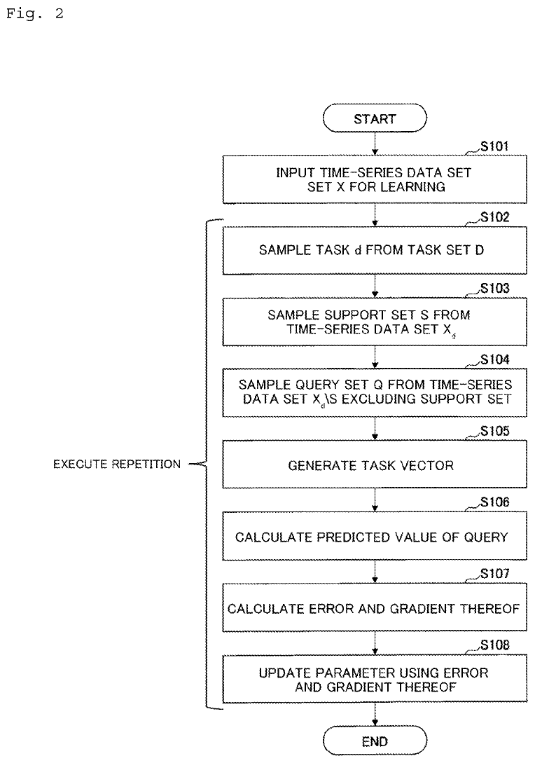

Next, a flow of learning processing executed by the learning apparatus 10 according to the present embodiment will be described with reference to FIG. 2. FIG. 2 is a flowchart showing an example of the flow of learning processing according to the present embodiment. It is assumed that learning target parameters stored in the storage unit 105 have been initialized by a known method (for example, random initialization, initialization according to a certain distribution, or the like).

First, the input unit 101 receives a time-series data set set X stored in the storage unit 105 (step S101).

Subsequent steps S102 to S108 are repeatedly executed until predetermined completion conditions are satisfied. The predetermined completion conditions include, for example, a condition that the learning target parameters have converged, a condition that the repetition has been executed a predetermined number of times, and the like.

The learning unit 104 samples a task d from a task set D (step S102).

Next, the learning unit 104 samples a support set S from a time-series data set X_{d} included in the time-series data set set X input in step S101 (step S103).

Next, the learning unit 104 samples a query set Q from a set obtained by excluding the support set S from the time-series data set X_{d} (that is, a set of time series that are not included in the support set S among time series included in the time-series data set X_{d}) (step S104).

Subsequently, the task vector generation unit 102 generates a task vector representing the property of the task d (that is, the task d sampled in step S102) corresponding to the support set S using the support set S sampled in step S103 (step S105). The task vector generation unit 102 may generate the task vector according to, for example, the above formula (1).

Next, the prediction unit 103 calculates a predicted value at each time t in each query using the task vector generated in step S105 and each query included in the query set Q sampled in step S104 (step S106). For example, the prediction unit 103 may calculate the predicted value at each time t according to the above formulas (2) to (4) using the task vector generated in step S105 and the corresponding query for each query included in the query set Q.

Next, the learning unit 104 calculates an error between a value at the time t in each query included in the query set Q sampled in step S104 and a predicted value thereof and calculates a gradient with respect to the learning target parameters (step S107). The learning unit 104 may calculate the error according to, for example, the above formula (6). Further, the gradient may be calculated by a known method such as an error back propagation method.

Then, the learning unit 104 updates the learning target parameters such that the error decreases using the error calculated in step S107 and the gradient thereof (step S108). The learning unit 104 may update the learning target parameters according to a known update formula or the like.

As described above, the learning apparatus 10 according to the present embodiment can learn parameters of a prediction model realized by the task vector generation unit 102 and the prediction unit 103. At the time of testing, a support set and queries of a target task d* may be input through the input unit 101, a task vector may be generated by the task vector generation unit 102 from the support set, and then predicted values at further time may be calculated from the task vector and the queries. The learning apparatus 10 need not include the learning unit 104 at the time of testing, and may be referred to as, for example, a “prediction apparatus” or the like.

<Evaluation Results>

Next, evaluation results of a prediction model learned by the learning apparatus 10 according to the present embodiment will be described. In the present embodiment, as an example, a prediction model was evaluated using time-series data. Test errors are shown in Table 1 below as evaluation results.

TABLE 1

| Proposed | LSTM | | | NN | | | Linear | | | |
|---|---|---|---|---|---|---|---|---|---|---|
| method | MAML | DI | DS | MAML | DI | DS | MAML | DI | DS | Pre |
| 0.224 | 0.235 | 0.231 | 0.295 | 0.293 | 0.272 | 0.299 | 0.305 | 0.312 | 0.387 | 0.285 |

Here, the proposed method is the prediction model learned by the learning apparatus 10 according to the present embodiment. In addition, LSTM, NN (neural network), and Linear (linear model) are existing methods for comparison, MAML is model unknown meta learning, and DI is a case in which the same model is used for all tasks, and DS is a case in which different models are used for respective tasks. Further, Pre is a method of using a value at a previous time as a predicted value.

As shown in Table 1 above, the prediction model trained by the learning apparatus 10 according to the present embodiment achieves less test errors as compared to the existing methods.

As described above, the learning apparatus 10 according to the present embodiment can learn a prediction model from a set of series data of a plurality of tasks, and even when only a small amount of learning data is provided in a target task, achieve high performance.

<Hardware Configuration>

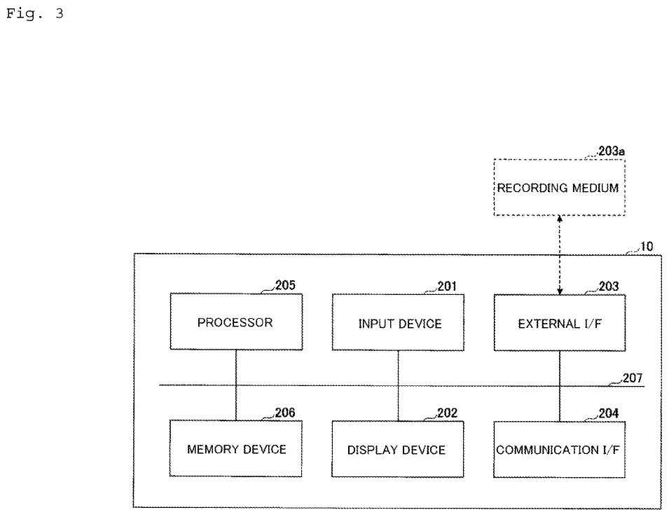

Finally, a hardware configuration of the learning apparatus 10 according to the present embodiment will be described with reference to FIG. 3. FIG. 3 is a diagram showing an example of the hardware configuration of the learning apparatus 10 according to the present embodiment.

As shown in FIG. 3, the learning apparatus 10 according to the present embodiment is realized by a general computer or a computer system and includes an input device 201, a display device 202, an external I/F 203, a communication I/F 204, a processor 205, and a memory device 206. These hardware components are connected such that they can communicate via a bus 207.

The input device 201 is, for example, a keyboard, a mouse, a touch panel, or the like. The display device 202 is, for example, a display or the like. The learning apparatus 10 may not include at least one of the input device 201 and the display device 202.

The external I/F 203 is an interface with an external device such as a recording medium 203a. The learning apparatus 10 can perform reading or writing of the recording medium 203a, and the like via the external I/F 203. For example, the recording medium 203a may store one or more programs that realize each functional unit (the input unit 101, the task vector generation unit 102, the prediction unit 103, and the learning unit 104) included in the learning apparatus 10. The recording medium 203a includes, for example, a compact disc (CD), a digital versatile disk (DVD), a secure digital (SD) memory card, a universal serial bus (USB) memory card, and the like.

The communication I/F 204 is an interface for connecting the learning apparatus 10 to a communication network. One or more programs that realize each functional unit included in the learning apparatus 10 may be acquired (downloaded) from a predetermined server device or the like via the communication I/F 204.

The processor 205 is, for example, various arithmetic operation devices such as a central processing unit (CPU) and a graphics processing unit (GPU). Each functional unit included in the learning apparatus 10 is realized, for example, by processing caused by one or more programs stored in the memory device 206 to be executed by the processor 205.

The memory device 206 is, for example, various storage devices such as a hard disk drive (HDD), a solid state drive (SSD), a random access memory (RAM), a read only memory (ROM), and a flash memory. The storage unit 105 included in the learning apparatus 10 is realized by, for example, the memory device 206. However, the storage unit 105 may be realized by, for example, a storage device (for example, a database server or the like) connected to the learning apparatus 10 via a communication network.

The learning apparatus 10 according to the present embodiment can realize the above-described learning processing by including the hardware configuration shown in FIG. 3. The hardware configuration shown in FIG. 3 is an example, and the learning apparatus 10 may have other hardware configurations. For example, the learning apparatus 10 may include a plurality of processors 205 or a plurality of memory devices 206.

The present invention is not limited to the above-described embodiment specifically disclosed, and various modifications and changes, combinations with known technologies, and the like are possible without departing from the description of the claims.

### REFERENCE SIGNS LIST

10 Learning apparatus
101 Input unit
102 Task vector generation unit
103 Prediction unit
104 Learning unit
105 Storage unit
201 Input device
202 Display device
203 External I/F
203a Recording medium
204 Communication I/F
205 Processor
206 Memory device
207 Bus

1. A learning method, executed by a computer including a memory and processor, the method comprising:
receiving a series data set set X={Xd}d∈D composed of series data sets Xd for learning in a task d∈D when a task set is set as D;
sampling the task d from the task set D and then sampling a first subset from a series data set Xd corresponding to the task d and a second subset from a set obtained by excluding the first subset from the series data set Xd;
generating a task vector representing characteristics of the first subset using parameters of a first neural network;
calculating, from the task vector and series data included in the second subset, a predicted value of each value included in the series data using parameters of a second neural network; and
updating learning target parameters including the parameters of the first neural network and the parameters of the second neural network using an error between each value included in the series data and the predicted value corresponding to each value.

2. The learning method according to claim 1, wherein the first neural network is a bidirectional LSTM, and
the generating includes generating each latent layer at each time of the bidirectional LSTM as the task vector.

3. The learning method according to claim 1, wherein the second neural network includes an LSTM, and
the calculating includes
generating each latent layer of the LSTM at each time as a vector representing characteristics of the series data included in the second subset, and
calculating the predicted value of each value included in the series data from the task vector and the vector representing the characteristics of the series data.

4. The learning method according to claim 3, wherein the second neural network includes a neural network having an attention mechanism, and
the calculating includes
calculating the predicted value of each value included in the series data through the neural network having the attention mechanism.

5. The learning method according to claim 1, wherein the updating includes
calculating the error using an expected test error or a negative log likelihood, and updating the learning target parameters using the calculated error.

6. A learning apparatus comprising:
a memory; and
a processor configured to execute
receiving a series data set set X={Xd}d∈D composed of series data sets Xd for learning in a task d∈D when a task set is set to D;
sampling the task d from the task set D and then sampling a first subset from a series data set Xd corresponding to the task d and a second subset from a set obtained by excluding the first subset from the series data set Xd;
generating a task vector representing characteristics of the first subset using parameters of a first neural network;
calculating, from the task vector and series data included in the second subset, a predicted value of each value included in the series data using parameters of a second neural network; and
updating learning target parameters including the parameters of the first neural network and the parameters of the second neural network using an error between each value included in the series data and the predicted value corresponding to each value.

7. A non-transitory computer-readable recording medium having computer-readable instructions stored thereon, which when executed, cause a computer including a memory and a processor to execute the learning method according to claim 1.
